(19) United States
(12) Patent Application Publication
(10) Pub. No.: US 2008/0156383 A1
(43) Pub. Date: Jul. 3, 2008

(54) Fluid-transfer system

(75) Inventors: Jian YE, Dunlap, IL (US); Zhenyu LI, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/987,137

(22) Filed: Nov. 27, 2007

Related U.S. Application Data
(60) Provisional application No. 60/861,268, filed on Nov. 28, 2006.

(51) Int. Cl. B67D 5/00

(52) U.S. Cl. 137/565.16

(57) ABSTRACT

A fluid-transfer system includes a pump, a valve member for metering fluid pumped by the pump, and controls that regulate the position of the valve member. The controls may include an electric actuator operable to generate movement of the valve member in a first direction using activation current. The controls may also include one or more springs that provide resistance force that urges the valve member in a second direction, opposite the first direction. A spring rate of the resistance force may vary as a function of the position of the valve member in such a manner that a relationship between a flow rate of the fluid pumped through the pump and the activation current is more linear than a relationship between a position of the valve member and the activation current.

This application claims the benefit of priority under 35 U.S.C. § 119(e) of U.S. Provisional Application No. 60/861,268, filed Nov. 28, 2006, the disclosure of which is incorporated herein by reference.

### TECHNICAL FIELD

The present disclosure relates to fluid-transfer systems, and more particularly, to fluid-transfer systems that include valves for metering fluid flow.

### BACKGROUND

Many systems employ fluid-transfer systems to supply fluid from one component to another for various purposes. Such systems often include one or more valves for metering flow of the fluid through the system. Some such valves include a spring for biasing a valve member of the valve in one direction and a controllable electric actuator for urging the valve member in an opposite direction against the force supplied by the biasing member. Many such biasing springs have a constant spring rate. Operating a valve with a constant spring rate may compromise operation of the valve for some applications and in some circumstances because the biasing force may not provide optimal variation in the positioning of the valve.

U.S. Pat. No. 6,390,129 to Jansen et al. (“the '129 patent”) a valve with an electric solenoid for urging a valve member in a first direction and a plurality of valve springs that engage in stages as the valve member moves in the first direction to provide progressively increasing biasing force. The valve of the '129 patent includes a coil spring that always resists movement of the valve member in the first direction and a plurality of finger springs, each finger spring engaging a stop at a predetermined point in the range of travel of the valve member to assist the coil spring in biasing the valve member opposite the first direction. Thus, the biasing force varies nonlinearly with respect to the position of the valve member. The '129 patent teaches that biasing springs and valve are configured in a way that helps make a relationship between the activation current for the electric solenoid and the position of the valve member more linear.

Although the '129 patent discloses a valve with multiple biasing springs that engage in stages at different points along the range of travel of the valve member, certain disadvantages persist. For example, a linear relationship between the activation current applied to the electric solenoid and the position of the valve member may not be desirable for some applications.

The fluid-transfer system and methods of the present disclosure solve one or more of the problems set forth above.

### SUMMARY OF THE INVENTION

One disclosed embodiment relates to a fluid-transfer system. The fluid-transfer system may include a pump, a valve member for metering fluid pumped by the pump, and controls that regulate the position of the valve member. The controls may include an electric actuator operable to generate movement of the valve member in a first direction using activation current. The controls may also include one or more springs that provide resistance force that urges the valve member in a second direction, opposite the first direction. A spring rate of the resistance force may vary as a function of the position of the valve member in such a manner that a relationship between a flow rate of the fluid pumped through the pump and the activation current is more linear than a relationship between a position of the valve member and the activation current.

Another embodiment relates to a fluid-transfer system. The fluid-transfer system may include a pump, a valve member for metering fluid pumped by the pump, and controls that regulate the position of the valve member. The controls may include an electric actuator operable to generate movement of the valve member in a first direction using activation current, wherein a relationship between a position of the valve member in the first direction and a rate of flow of the pumped fluid is nonlinear. The controls may also include one or more springs that provide a resistance force that urges the valve member in a second direction, opposite the first direction. A spring rate of the resistance force may vary as a function of the position of the valve member.

A further embodiment relates to a method of transferring fluid. The method may comprise pumping fluid with a pump and metering the flow rate of the pumped fluid with a valve member. Metering the flow rate of the pumped fluid with valve member may include activating an electric actuator to urge the valve member in a first direction by supplying activation current to the electric actuator. The method may also include resisting movement of the valve member in the first direction with resistance force from one or more springs, which may include producing nonlinearity in a relationship between the position of the valve member and the activation current by varying a spring rate of the resistance force as a function of the position of the valve member.

### BRIEF DESCRIPTION OF THE DRAWINGS

FIG. 1 is a schematic illustration of a fluid-transfer system according to the present disclosure;

FIG. 2 is a close-up illustration of the valve shown in FIG. 1;

FIG. 3A illustrates one operating-parameter relationship of a fluid-transfer system according to the present disclosure;

FIG. 3B illustrates another operating-parameter relationship of a fluid-transfer system according to the present disclosure;

FIG. 3C illustrates another operating-parameter relationship of a fluid-transfer system according to the present disclosure;

FIG. 4 illustrates another operating-parameter relationship of a fluid-transfer system according to the present disclosure; and

FIG. 5 illustrates another operating-parameter relationship of a valve according to the present; and

FIG. 6 illustrates another operating-parameter relationship of a fluid-transfer system according to the present disclosure.

### DETAILED DESCRIPTION

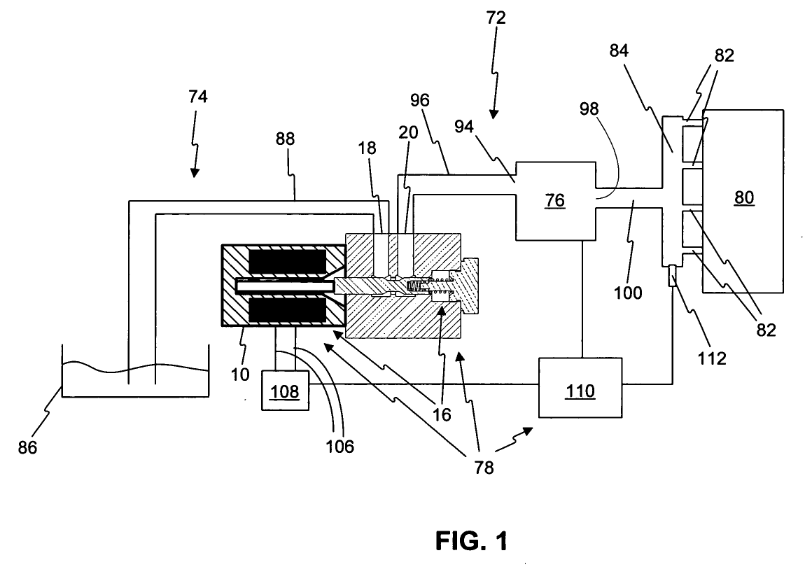

FIG. 1 illustrates one embodiment of a fluid-transfer system 72 according to the present invention. Fluid-transfer system 72 may include a fluid supply 74, a pump 76, a valve 10 and controls 78. As FIG. 1 shows, in some embodiments, pump 76 and valve 10 may be separate components. Alternatively, valve 10 may be an integral part of pump 76.

Depending on what purpose fluid-transfer system 72 serves, fluid-transfer system 72 may include various other components. In some embodiments, fluid-transfer system 72 may be a fuel system for an engine 80. In such embodiments, fluid-transfer system 72 may, for example, include a plurality of fuel injectors 82 for injecting fuel into the engine. In some embodiments, fluid-transfer system 72 may have a so-called “common-rail” configuration with a manifold or rail 84 that supplies pressurized fuel to a plurality of fuel injectors 82.

Fluid supply 74 may include any component or components operable to provide fuel to valve 10 and pump 76. For example, fluid supply 74 may include a fluid reservoir 86 and a supply line 88. Fluid supply 74 may supply various types of fluid. In embodiments where fluid-transfer system 72 is a fuel system of an engine 80, fluid supply 74 may supply fuel.

Pump 76 may be any type of device operable to propel fluid through fluid-transfer system 72, including, but not limited to, a gear pump, a piston pump, a vane pump, a diaphragm pump, and a centrifugal pump. Pump 76 may use various types of power to propel fluid. In some embodiments, pump 76 may be an electric pump. Alternatively, pump 76 may be a mechanically driven pump. Pump 76 may have an inlet port 94 for receiving fluid and an outlet port 98 for discharging the fluid propelled by pump 76.

Pump 76 and valve 10 may connect to one another and fluid supply 74 in a manner allowing pump 76 to pump fluid received from fluid supply 74 while valve 10 meters the fluid pumped by pump 76. For example, as FIG. 1 shows, an inlet port 18 of valve 10 may connect to fluid reservoir 86 through supply line 88, and an outlet port 20 of valve 10 may connect to inlet port 94 of pump 76 through a supply line 96. Outlet port 98 of pump 76 may connect to manifold 84 through a supply line 100. Such a configuration may allow pump 76 to draw fluid from fluid supply 74 through valve 10 and discharge the fluid into supply line 98 for delivery to manifold 84, while valve 10 meters the pumped fluid on an upstream side of inlet port 18.

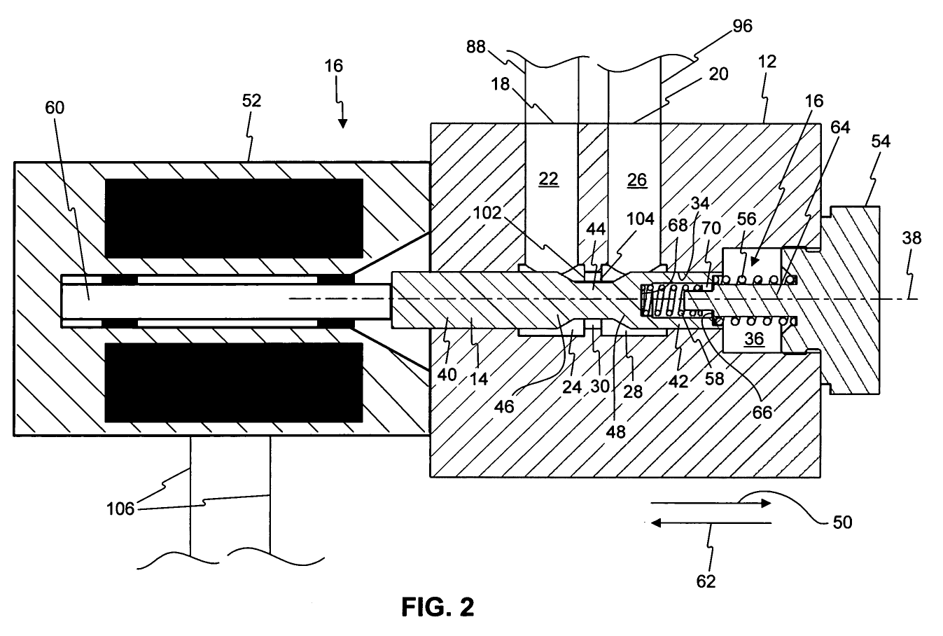

FIG. 2 shows valve 10 in greater detail. Valve 10 may include a housing 12, a valve member 14 for metering the fluid pumped by pump 76, and valve controls 16. Housing 12 may include inlet port 18, outlet port 20; one or more passages and/or cavities connected between inlet port 18 and outlet port 20; and one or more features for accommodating valve member 14 and/or one or more components of valve controls 16. Connected between inlet port 18 and outlet port 20, housing 12 may have, for example, a passage 22 extending from port 18 to a cavity 24, a passage 26 extending from port 20 to a cavity 28, and a passage 30 extending between cavities 24, 28. Housing 12 may have an opening 102 at the interface between cavity 24 and passage 30, as well as an opening 104 at the interface between cavity 28 and passage 30. Housing 12 may also have a passage 32 that extends from one side of cavity 24 and a passage 34 that extends from an opposite side of cavity 28. Additionally, housing 12 may have a cavity 36 connected to an end of passage 34 opposite cavity 28. An axis 38 may extend through the center of passage 32, passage 30, and passage 34.

Valve member 14 may reside at least in part within housing 12. For example, in some embodiments, valve member 14 may extend at least partially through each of passage 32, cavity 24, passage 30, cavity 28, and passage 34. A portion 40 and a portion 42 of valve member 14 may have side surfaces that engage side surfaces of passages 32 and 34, respectively, in a manner to guide valve member 14 along axis 38.

Valve member 14 may have various designs and various provisions for metering fluid flow between ports 18, 20 and thus through pump 76. In some embodiments, valve member 14 may be a spool-type valve member. Valve member 14 may have portions in and/or adjacent passage 30 that present varying resistance to flow through passage 30 as valve member 14 moves along axis 38. For example, between portions 40, 42, valve member 14 may have a reduced portion 44 connected to portions 40, 42 by tapered portions 46, 48. Tapered portions 46, 48 may cooperate with openings 102, 104 to meter fluid flow through valve 10. With valve member 14 in the position shown in FIG. 1, reduced portion 44 may occupy all of passage 30, thereby leaving a relatively large portion of passage 30 and openings 102, 104 open and allowing fluid to flow relatively freely between input port 18 and output port 20. Accordingly, the position of valve member 14 shown in FIG. 2 may constitute a “fully open” position. If valve member 14 moves in a direction 50 from the position shown in FIG. 2, tapered portion 46 may advance toward and then into opening 102, thereby restricting fluid flow between inlet port 18 and outlet port 20 to a greater degree. As valve member 14 continues moving in direction 50, portion 40 may eventually move into opening 102 and substantially block fluid flow between inlet port 18 and outlet port 20. In some embodiments, the relationship between the position of valve member 14 and fluid flow through valve 10 and pump 76 may be nonlinear.

Valve controls 16 may include any component or components that control the position of valve member 14 to control fluid flow between inlet port 18 and outlet port 20. For example, valve controls 16 may include a controllable actuator 52, a stop 54, and springs 56, 58. Controllable actuator 52 may be any type of component that can supply an adjustable amount of force or torque. In some embodiments, controllable actuator 52 may be an electric actuator, such as a solenoid with a plunger 60 that engages valve member 14. When activated with activating current via power lines 106, controllable actuator 16 may urge valve member 14 in direction 50. The amount of force exerted by controllable actuator 52 may depend on the magnitude of the activation current supplied to controllable actuator 52. In some embodiments, the relationship between the activation current and the force exerted by controllable actuator 52 may be approximately linear. When deactivated, controllable actuator 52 may limit movement of valve member 15 in a direction 62, opposite direction 50. For example, controllable actuator 52 may prevent valve member 14 from moving any farther in direction 62 than FIG. 2 shows.

Springs 56, 58 may provide resistance force that urges valve member 14 in direction 62, thereby resisting movement of valve member 14 in direction 50. Stop 54 may limit movement of springs 56, 58 in direction 50, and each spring 56, 58 may resist movement of valve member 14 in direction 50 over at least one range of motion. Stop 54 may be fixedly attached to housing, such as by engagement between threads (not shown) on stop 54 and threads (not shown) on housing 12. Stop 54 may close off cavity 36, and stop 54 may have a post 64 that extends into cavity 36 and passage 34. Post 64 may have a base portion with one cross-section, an end portion with a smaller cross-section, and a shoulder 66 between the base portion and the end portion.

Spring 56 may surround the base portion of post 64 with one end of spring 56 disposed adjacent an end surface of portion 42 of valve member 14 and the opposite end of spring 56 disposed adjacent a surface of stop 54 around post 64. Spring 56 may have a free length such that it is compressed between valve member 14 and stop 56 with valve member 14 disposed as far in direction 62 as controllable actuator 52 will allow valve member 14 to travel. Thus, when controllable actuator 52 does not apply force to valve member 14 in direction 50, spring 56 may drive valve member 14 as far in direction 62 as controllable actuator 52 will allow. Accordingly, the furthest possible position of valve member 14 in direction 62 may constitute the default position of valve member 14.

Spring 58 may sit within a recess in portion 42 of valve member 14 with one end of spring 58 disposed adjacent a surface 68 of the recess and the opposite end of spring 58 disposed adjacent shoulder 66 of post 64. The end portion of post 64 may extend partway inside spring 58. Spring 58 may have a free length shorter than the space that exists between shoulder 66 and surface 68 with valve member 14 disposed in its default position. Accordingly, with valve member 14 disposed in its default position, as shown in FIG. 2, a gap 70 may exist between spring 58 and shoulder 66, and spring 58 may exert no force on valve member 14. In other words, with valve member 14 disposed in its default position, spring 58 may not contribute to the resistance force that urges valve member 14 in direction 62.

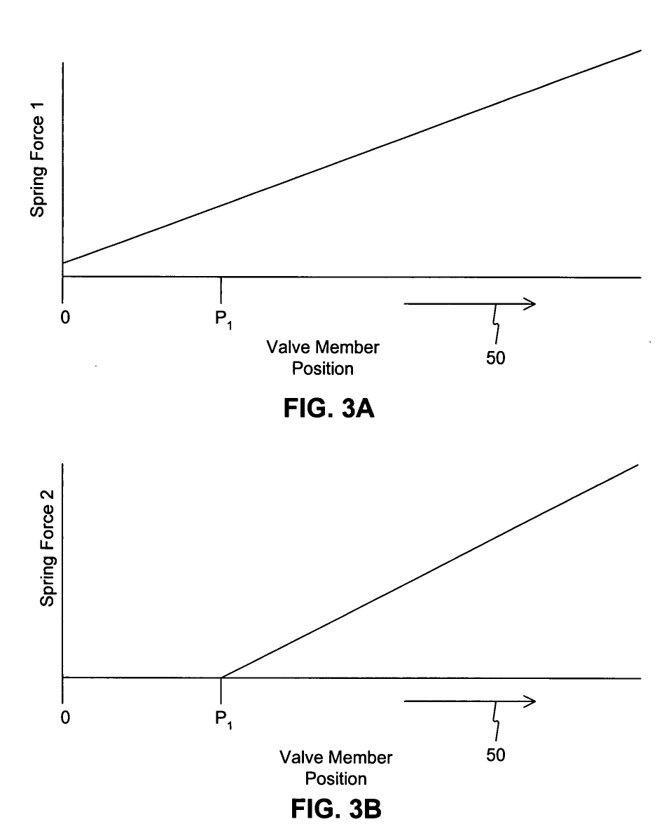

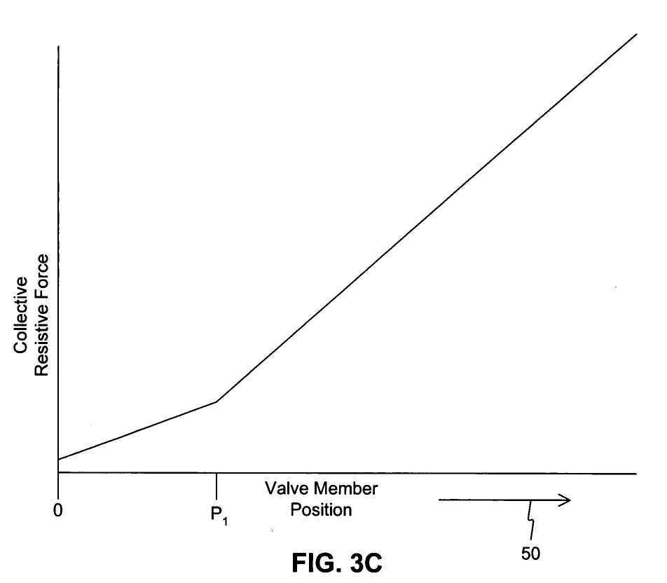

The position of valve member 14 and, thus, the restriction to fluid flow between inlet port 18 and outlet port 20 may be adjusted by adjusting the amount of force that controllable actuator 52 applies to valve member 14 in direction 50. The amount of force that controllable actuator 52 must apply in direction 50 to move valve member 14 to various positions along axis 38 may depend on how the forces that springs 56, 58 apply to valve member 14 vary as a function of the position of valve member 14, as well as fluid forces on valve member 14. FIG. 3A provides one example of how the force exerted on valve member 14 by spring 56 may vary as a function of the position of valve member 14. FIG. 3B provides one example of how the force exerted on valve member 14 by spring 58 may vary as a function of the position of valve member 14. FIG. 3C shows how the total resistance force that springs 56, 58 exert against valve member 14 in direction 62 may vary as a function of the position of valve member 14 as a result of springs 56, 58 exerting the individual forces shown in FIGS. 2A, 2B, respectively. In each of FIGS. 2A-2C, the “0” position on the horizontal axis corresponds to the default position of valve member 14, and increasing values along the horizontal axis correspond to positions of valve member 14 increasingly distant from the default position in direction 50.

When controllable actuator 52 is activated to move valve member 14 away from its default position in direction 50, spring 56 may apply resistance against controllable actuator 52, but spring 58 will not apply resistance against controllable actuator 52 because spring 58 is not initially compressed between surface 68 and shoulder 66. Accordingly, the total resistance applied against controllable actuator 52 may initially equal the resistance supplied by spring 56 alone.

As controllable actuator 52 drives valve member 14 further in direction 50, valve member 14 will eventually reach a position where gap 70 has closed and spring 58 is compressed between surface 68 and shoulder 66. This position is indicated as P₁ in FIGS. 2A-2C. As controllable actuator 52 drives valve member 14 beyond position P1 in direction 50, springs 56, 58 may both exert resistance against controllable actuator 52.

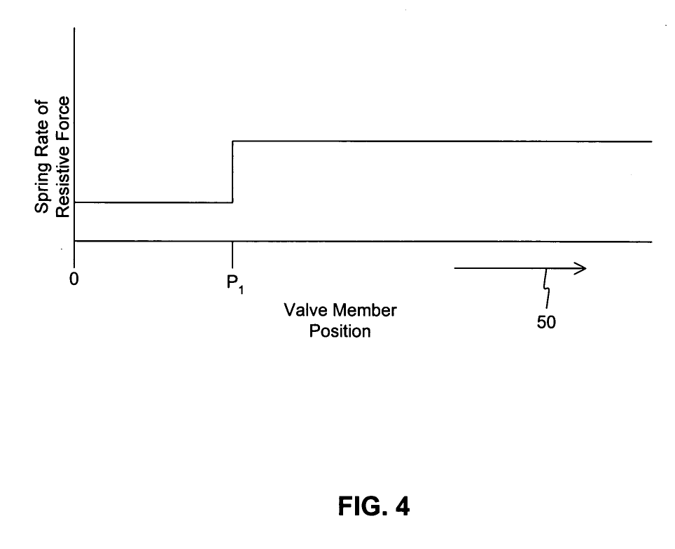

Thus, the resistance that springs 56, 58 collectively exert against the force from controllable actuator 52 may have a spring rate that varies as a function of the position of valve member 14. FIG. 4 illustrates how the spring rate of the resistance shown in FIG. 3C varies as a function of the position of valve member 14. As FIG. 4 shows, between the default position of valve member 14 and position P₁, the resistance exerted against controllable actuator 52 may have a first spring rate, and, at positions beyond position P₁ in direction 50, the resistance exerted against controllable actuator 52 may have a second, higher spring rate. The spring rate of the resistance force for the range of positions between the default position and position P₁ may be the spring rate of the spring 56 by itself, and the spring rate of the resistance force for the range of positions beyond position P₁ in direction 50 may be the sum of the spring rate of spring 56 and the spring rate of spring 58.

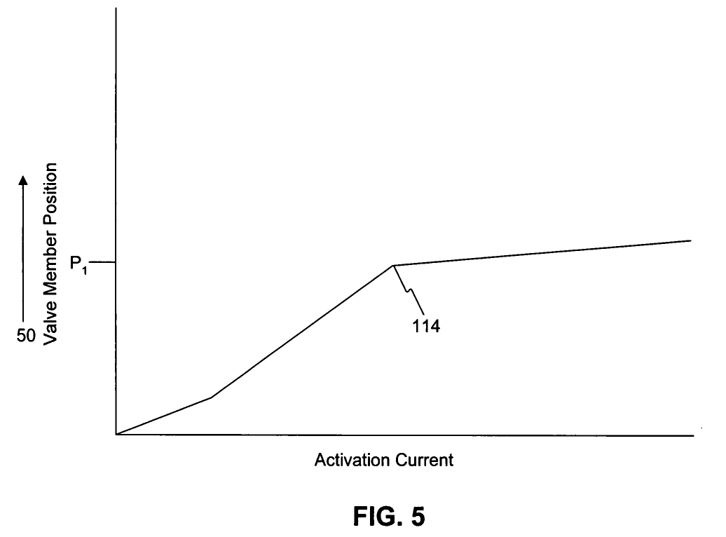

Due to the variation in the spring rate of the resistance force supplied by springs 56, 58, the relationship between the resistance force and the position of valve member 14 may be nonlinear, as shown in FIG. 3C. In some embodiments, the nonlinear relationship between the resistance force and the position of valve member 14 may generate nonlinearity in the relationship between the position of valve member 14 and the activation current supplied to controllable actuator 52. For example, in embodiments where the there is a substantially linear relationship between the activation current and the force exerted by controllable actuator 52, the nonlinear relationship between the resistance force exerted by springs 56, 58 in direction 62 and the position of valve member 14 may produce nonlinearity in the relationship between the activation current and the position of valve member 14. FIG. 5 illustrates one example of a nonlinear relationship that may exist between the activation current and the position of valve member 14 as a result of the nonlinear variation in the resistance force provided by springs 56, 58. In FIG. 5, the sharp transition 114 in the relationship between the position of valve member 14 and the activation current may occur as a result of the spring 58 engaging and contributing to the resistance force exerted on valve member 14 in direction 62. A nonlinear relationship between the activation current and the position of valve member 14 may also result in a nonlinear relationship between the opening area of valve 10 and the activation current.

Various other factors may also affect the position of valve member 14. For example, with valve member 14 and housing 12 configured in the manner shown in FIG. 2, fluid flowing through valve member 14 may exert unbalanced force on valve member 14 in direction 50 or direction 62. The magnitude of this unbalanced fluid force may depend on the flow rate of the fluid pumped through valve 10, which depends in part on the position of valve member 14. Accordingly the magnitude of the fluid force on valve member 14 may depend on the position of valve member 14. Such variation in fluid force on valve member 14 constitutes another variable that must be accounted for in metering the flow rate of the fluid pumped by pump 76.

Valve 10 is not limited to the configuration shown in FIG. 2. For example, valve 10 may include a single spring with a variable spring rate similar to that shown in FIG. 4, in place of springs 56, 58. Alternatively, valve 10 may include other springs, in addition to springs 56, 58.

Returning to FIG. 1, controls 78 may include valve controls 16, a power regulator 108, a controller 110, and a pressure sensor 112. Power regulator 108 may be operable to control the activation current supplied to controllable actuator 52 via power lines 106. Controller 110 may include one or more processors (not shown) and one or more memory devices (not shown). Controller 110 may be operatively connected to pump 76, so that controller 110 may control whether pump 76 pumps fluid. Controller 110 may also be operatively connected to power regulator 108 in a manner allowing controller 110 to control the activation current supplied to controllable actuator 52 by controlling power regulator 108.

Pressure sensor 112 may sense the pressure of fluid discharged by pump 76. For example, pressure sensor 112 may sense the pressure of fluid in manifold 84. Pressure sensor 112 may be communicatively linked to controller 110, so that pressure sensor may provide controller 110 a signal indicating the sensed fluid pressure.

Fluid-transfer system 72 is not limited to the configuration shown in FIG. 1. For example, rather than metering fluid on an upstream side of inlet port 94 of pump 76, valve 10 may meter fluid on a downstream side of outlet port 98 of pump 76 or between inlet port 94 and 98. Additionally, fluid-transfer system 72 may include various other combinations and arrangements of components connected to pump 76 and valve 10. Additionally, fluid-transfer system 72 may be a type of system other than a fuel system for engine 80, such as, for example, a hydraulic system.

### INDUSTRIAL APPLICABILITY

Fluid-transfer system 72 may have application in any system requiring a metered supply of fluid, and valve 10 may have application in any fluid-transfer system requiring fluid metering. Controls 78 of fluid-transfer system may control pump 76 and valve 10 based on various operating conditions. For example controller 110 may control whether pump 76 pumps fluid based on whether engine 80 is running. Additionally, controller 110 may adjust the operation of valve 10 by regulating the activation current supplied to controllable actuator 52 to meter the flow rate of the pumped fluid based on various operating parameters. In some embodiments, controller 110 may adjust the activation current based on the pressure sensed by pressure sensor 112. For example, controller 110 may adjust the activation current in order to attempt to maintain the sensed pressure of the fluid discharged by pump 76 at a target value.

The disclosed embodiments of fluid-transfer system 72 may provide certain performance advantages. For example, configuring valve 10 such that the spring rate of the resistance exerted against controllable actuator 52 increases over the range of motion of valve member 14 may provide certain performance advantages. A relatively low spring rate at positions close to the default position of valve member 14 may allow controllable actuator 52 to adjust the position of valve member 14 with relatively little force at such positions. A high spring rate at positions of valve member 14 farther from its home position may allow controllable actuator 52 to use relatively high force to adjust the position of valve member 14 at such positions. Accordingly, increasing the spring rate over the range of motion of valve member 14 may allow using a wide range of force from controllable actuator 52 to control the position of valve member 14. This may facilitate precisely controlling fluid flow between ports 18, 20 because any particular change in the magnitude of the force from controllable actuator 52 may produce a relatively small change in fluid flow.

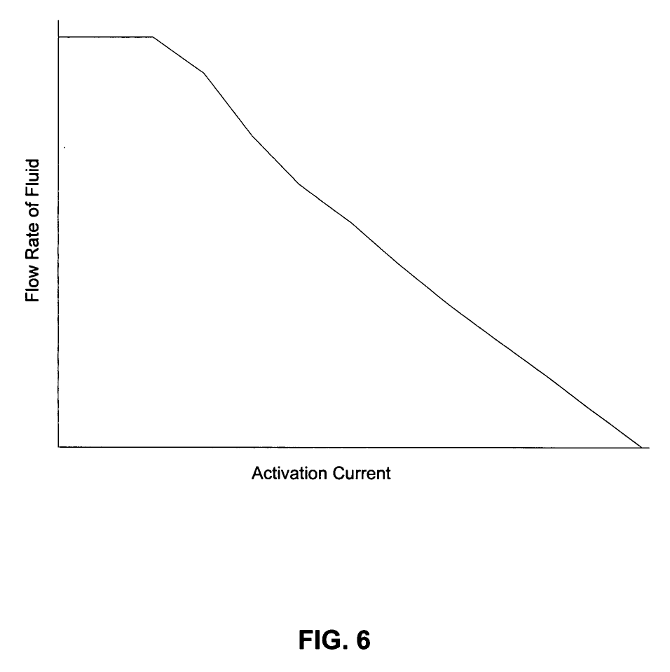

The nonlinearities in the relationship between the position of valve member 14 and the resistance force provided by springs 56, 58, along with resulting nonlinearities in the relationship between the position of valve member 14 and the activation current supplied to controllable actuator 52 may also allow other performance advantages. For example, the nonlinearities in the relationship between the position of valve member 14 and the activation current may be tailored to at least partially coincide with and at least partially offset nonlinearities in the relationship between the position of valve member 14 and the flow rate of the pumped fluid through valve 10 and pump 76. Similarly, the nonlinearities in the relationship between position and activation current may be tailored to compensate for variations in the fluid force on valve member 14. By using a nonlinear relationship between the activation current and the position of valve member 14 to compensate for such other variables, a relatively linear relationship between activation current and the rate of fluid flow through valve 10 and pump 76 may be achieved. For example, the relationship shown in FIG. 6 may be achieved. As can be seen by comparing FIG. 6 to FIG. 5, the disclosed embodiments may provide a relationship between activation current and flow rate through pump 76 and valve 10 (FIG. 6) that is more linear than the relationship between activation current and position (FIG. 5). The linearity of these relationships may be compared, for example, by determining a best-fit line for data associated with each relationship and comparing how closely the data for each relationship fits its associated best-fit line, such as by using a least squares approach.

By providing a relatively linear relationship between the activation current supplied to controllable actuator 52 and the rate of flow of the fluid through valve 10 and pump 76, the disclosed embodiments may allow precise and intuitive metering of the fluid flow through fluid-transfer system 72. For any desired change in flow rate of the fluid, controls 78 need only change the activation current by an amount approximately proportional to the desired flow-rate adjustment.

Additionally, controlling valve 10 based on the pressure of the fluid discharged by pump 76 may further facilitate precise metering of the fluid flow. Sensing the pressure of the fluid discharged by pump 76 may provide a very accurate indication of the effect of any adjustments to the activation current on the flow rate, so that the activation current can be adjusted until the desired flow rate is actually achieved.

It will be apparent to those skilled in the art that various modifications and variations can be made in the valve and methods without departing from the scope of the disclosure. Other embodiments of the disclosed valve and methods will be apparent to those skilled in the art from consideration of the specification and practice of the valve and methods disclosed herein. It is intended that the specification and examples be considered as exemplary only, with a true scope of the disclosure being indicated by the following claims and their equivalents.

What is claimed is:

1. A fluid-transfer system, comprising:
a pump;
a valve member for metering fluid pumped by the pump;
controls that regulate the position of the valve member, including
an electric actuator operable to generate movement of the valve member in a first direction using activation current;
one or more springs that provide resistance force that urges the valve member in a second direction, opposite the first direction, wherein a spring rate of the resistance force varies as a function of the position of the valve member in such a manner that a relationship between a flow rate of the fluid pumped through the pump and the activation current is more linear than a relationship between a position of the valve member and the activation current.

2. The fluid-transfer system of claim 1, wherein a relationship between the position of the valve member and the flow rate of the fluid pumped by the pump is nonlinear.

3. The fluid-transfer system of claim 1, wherein the fluid pumped by the pump exerts a net fluid force on the valve member in at least one of the first direction and the second direction, the net fluid force varying as a function of the position of the valve member.

4. The fluid-transfer system of claim 1, wherein the controls regulate the activation current used by the electric actuator based at least in part on a pressure of fluid discharged by the pump.

5. The fluid-transfer system of claim 1, wherein the valve member includes a tapered surface that cooperates with an opening in the fluid-transfer system to meter the fluid pumped by the pump.

6. The fluid-transfer system of claim 4, wherein the valve member is a spool-type valve member.

7. The fluid-transfer system of claim 1, wherein the valve member meters the fluid pumped by the pump on an upstream side of an inlet of the pump.

8. The fluid-transfer system of claim 1, wherein:
the one or more springs include a plurality of springs; and
one or more of the plurality of springs contribute to the resistance force over only a subset of a range of travel of the valve member in the first direction.

9. The fluid-transfer system of claim 1, wherein:
wherein the electric actuator is disposed on a first side of the valve member; and
the one or more springs are disposed on a second side of the valve member.

10. The fluid-transfer system of claim 1, wherein the fluid-transfer system is a fuel system for an engine.

11. A fluid-transfer system, comprising:
a pump;
a valve member for metering fluid pumped by the pump;
controls that regulate the position of the valve member, including
an electric actuator operable to generate movement of the valve member in a first direction using activation current, wherein a relationship between a position of the valve member in the first direction and a rate of flow of the pumped fluid is nonlinear;
one or more springs that provide resistance force that urges the valve member in a second direction, opposite the first direction, wherein a spring rate of the resistance force varies as a function of the position of the valve member.

12. The fluid-transfer system of claim 11, wherein the one or more springs include a plurality of springs.

13. The fluid-transfer system of claim 13, wherein one or more of the plurality of springs contribute to the resistance force over only a portion of a range of travel of the valve member in the first direction.

14. The fluid-transfer system of claim 11, wherein the controls regulate the activation current based at least in part on a pressure of fluid discharged by the pump.

15. The fluid-transfer system of claim 11, wherein the valve member is a spool-type valve member.

16. The fluid-transfer system of claim 14, wherein the valve member includes a tapered surface that cooperates with an opening in the fluid-transfer system to meter the pumped fluid.

17. A method of transferring fluid, the method comprising:
pumping fluid with a pump; and
metering the flow rate of the pumped fluid with a valve member, including controlling the position of the valve member at least in part by
activating an electric actuator to urge the valve member in a first direction by supplying activation current to the electric actuator, and
resisting movement of the valve member in the first direction with resistance force from one or more springs, including producing nonlinearity in a relationship between the position of the valve member and the activation current by varying a spring rate of the resistance force as a function of the position of the valve member.

18. The method of claim 17, further including regulating the activation current based at least in part on a pressure of fluid discharged by the pump.

19. The method of claim 17, wherein metering the pumped fluid with the valve member includes metering the pumped fluid on an upstream side of an inlet of the pump.

20. The method of claim 17, wherein:
a relationship between a flow rate of the pumped fluid and the position of the valve member is nonlinear; and
varying the spring rate of the resistance force as a function of the position of the valve member includes varying the spring rate of the resistance force in a manner such that a relationship between the flow rate of the pumped fluid and the activation current is more linear than the relationship between the flow rate of the pumped fluid and the position of the valve member.
